(19) United States
(12) Patent Application Publication
(10) Pub. No.: US 2013/0345375 A1
(43) Pub. Date: Dec. 26, 2013

(54) OLEFIN POLYMERIZATION CATALYST COMPOSITION AND OLEFIN POLYMERIZATION PROCESS USING THE SAME

(71) Applicants: Sah-Mun HONG, Daejeon (KR); Hye-Sun CHOI, Seoul (KR)

(72) Inventors: Sah-Mun HONG, Daejeon (KR); Hye-Sun CHOI, Seoul (KR)

(73) Assignee: DAELIM INDUSTRIAL CO., LTD., Seoul (KR)

(21) Appl. No.: 13/533,000

(22) Filed: Jun. 26, 2012

(51) Int. Cl. C08F 4/6592; C08F 4/16

(52) U.S. Cl. 526/119; 502/113

(57) ABSTRACT

The olefin polymerization catalyst composition comprises an organometallic compound represented by Formula 1; an organic transition metal compound represented by Formula 2; an organic transition metal compound represented by Formula 3; and an aluminoxane.

(Cp′)ₗM¹R¹ₘR²ₙ Formula 1:
wherein M¹ is an element selected from the group of elements of Group 1, 2, 12, 13 and 14, (Cp′) is a cyclic hydrocarbyl group of 5 to 30 carbon atoms having at least 2 conjugated double bonds, R¹ and R² are independently a hydrocarbyl group of 1 to 24 carbon atoms, l is an integer of 1 to the valence of M¹, m and n are independently an integer of 0 to 2, and l+m+n is equal to the valence of M¹,

(4HInd)₂M²X₂ Formula 2:

M²X₄ Formula 3:
wherein in Formulas 2 and 3, (4HInd) is a group having tetrahydroindenyl nucleus, M² is titanium (Ti), zirconium (Zr) or hafnium (Hf), and X is a halogen atom.

### FIELD OF THE INVENTION

This invention relates to an olefin polymerization catalyst composition, and more particularly, to an olefin polymerization catalyst composition which has superior polymerization activity, and can easily control a molecular weight, a molecular weight distribution and a composition distribution of the produced olefin polymer or copolymer, and an olefin polymerization process using the same.

### BACKGROUND OF THE INVENTION

A polyolefin, especially an ethylene polymer or an ethylene/α-olefin copolymer has a superior impact strength, transparency and so on. To produce the above stated ethylene polymers, a metallocene catalyst system consisting of an organometallic compound (generally, metallocene) which has ligands such as a cyclopentadienyl group, an indenyl group, a cycloheptadienyl group, a fluorenyl group, and an activator such as aluminoxane has been used (see German Patent No. 3,007,725, U.S. Pat. Nos. 4,404,344, 4,874,880, 5,324,800, and so on). Recently, the metallocene compound and the activator are supported by an inorganic carrier to produce a non-uniform solid catalyst, and the non-uniform solid catalyst is used for a slurry or a gas phase polymerization process to control the particle shape of the produced polymer (see U.S. Pat. No. 4,808,561 and Korean Patent application No. 1998-44308). However, the conventional metallocene catalyst has disadvantages of high production cost due to its synthetic process by several reaction steps under complicated reaction conditions, and difficulty in easily controlling properties of olefin polymers as necessary.

### SUMMARY OF THE INVENTION

Therefore, it is an object of the present invention to provide an olefin polymerization catalyst composition which can be produced by a simple process and has a high catalytic activity.

It is another object of the present invention to provide an olefin polymerization catalyst composition which can produce a tailor-made olefin polymers having various properties by changing catalytic property variously, and an olefin polymerization process using the same.

It is also another object of the present invention to provide an olefin polymerization catalyst composition which can easily control a molecular weight, a molecular weight distribution and a composition distribution of the produced olefin polymer or copolymer by controlling components of the catalyst and reaction conditions (temperature, time), and an olefin polymerization process using the same.

In order to achieve these objects, the present invention provides an olefin polymerization catalyst composition comprising: an organometallic compound represented by Formula 1; an organic transition metal compound represented by Formula 2; an organic transition metal compound represented by Formula 3; and an aluminoxane,

(Cp′)lM¹R¹ₘR²ₙ Formula 1

in Formula 1, M¹ is an element selected from the group consisting of elements of Group 1, 2, 12, 13 and 14 of the Periodic Table, (Cp′) is a cyclic hydrocarbyl group of 5 to 30 carbon atoms having at least 2 conjugated double bonds, R¹ and R² are independently a hydrocarbyl group of 1 to 24 carbon atoms, l is an integer of 1 to the valence of M¹, m and n are independently an integer of 0 to 2, and l+m+n is equal to the valence of NA1

(4HInd)₂M²X₂ Formula 2

M²X₄ Formula 3

in Formulas 2 and 3, (4HInd) is a group having tetrahydroindenyl nucleus, M² is titanium (Ti), zirconium (Zr) or hafnium (Hf), and X is a halogen atom.

The present invention also provides an olefin polymerization process including the step of polymerizing at least one olefin in the presence of the polymerization catalyst composition.

The olefin polymerization catalyst composition according to the present invention can exhibit various properties by appropriate selection and combination of the components thereof. Therefore, its commercial availability is excellent because olefin polymers having various properties can be made to order. The catalyst composition of the present invention can be produced by a simple process. Therefore, time and process for producing the catalyst can be minimized. And, the catalyst composition of the present invention has high polymerization activity which remains constant unlike existing catalysts whose polymerization activity decreases with polymerization time, so that its commercial productivity is excellent. In addition, by using the olefin polymerization process according to the present invention, the molecular weight, the molecular weight distribution, and the composition distribution of the produced olefin polymer or copolymer can be easily controlled in an uniform phase (solution) or a non-uniform phase (gas or slurry) polymerization process.

### DETAILED DESCRIPTION OF THE INVENTION

A more complete appreciation of the invention, and many of the attendant advantages thereof, will be better appreciated by reference to the following detailed description.

An olefin polymerization catalyst composition according to the present invention comprises an organometallic compound represented by Formula 1; an organic transition metal compound represented by Formula 2; an organic transition metal compound represented by Formula 3; and an aluminoxane.

(Cp′)ₗM¹R¹ₘR²ₙ Formula 1:

In Formula 1, M¹ is an element selected from the group consisting of elements of Group 1, 2, 12, 13 and 14 of the Periodic Table. Examples of M¹ include Lithium (Li), Sodium (Na), Potassium (K), Magnesium (Mg), Zinc (Zn), Boron (B), Aluminum (AI), Gallium (Ga), Indium (In), Thallium (Tl), and so on. Preferably, M1 is Lithium (Li), Sodium (Na), Magnesium (Mg) or Aluminum (Al). (Cp′) is a cyclic hydrocarbyl group of 5 to 30, preferably 5 to 13 carbon atoms having at least 2, preferably 2 to 4, more preferably 2 or 3 conjugated double bonds. If necessary, (Cp′) can be partially substituted with substituents, for example, 1 to 6 substituents. Examples of (Cp′) include a substituted or non-substituted cyclopentadienyl group, indenyl group, azulenyl group, fluorenyl group and so on. The substituent may be same or different from each other, and is a radical selected from the group consisting of an alkyl, alkoxy, alkylsilyl, alkylsiloxy, alkylamino or haloalkyl group of 1 to 20 carbon atoms, an alkenyl or cycloalkyl group of 3 to 20 carbon atoms, an aryl, arylsilyl or aryloxy group of 6 to 20 carbon atoms, an arylalkyl or alkylaryl group of 7 to 20 carbon atoms, a halogen atom, and an amino group. R¹ and R² are independently a hydrocarbyl group of 1 to 24, preferably 1 to 12 carbon atoms, for example, an alkyl group such as methyl, ethyl, propyl, isopropyl, butyl, t-butyl, isobutyl, pentyl, hexyl, octyl, and so on, a cycloalkyl group such as cyclopentyl, cyclohexyl, cycloheptyl, and so on, an aryl group such as phenyl, an arylalkyl group such as benzyl, and so on. And, l is an integer of 1 to the valence of M¹, m and n are independently an integer of 0 to 2, and l+m+n is equal to the valence of M¹.

(4HInd)₂M²X₂ Formula 2

In Formula 2, (4HInd) is a group having tetrahydroindenyl nucleus, for example, a group having 4,5,6,7-tetrahydroindenyl nucleus, M2 is titanium (Ti), zirconium (Zr) or hafnium (Hf), and X is a halogen atom, for example, fluorine, chlorine, bromine, iodine and so on. The 4HInd may be unsubstituted or substituted by one or more substituents, for example, 1 to 11 substituents. The substituent may be same or different from each other, and is a radical selected from the group consisting of an alkyl, alkoxy, alkylsilyl, alkylsiloxy, alkylamino or haloalkyl group of 1 to 20 carbon atoms, an alkenyl or cycloalkyl group of 3 to 20 carbon atoms, an aryl, arylsilyl or aryloxy group of 6 to 20 carbon atoms, an arylalkyl or alkylaryl group of 7 to 20 carbon atoms, a halogen atom, and an amino group.

M²X₄ Formula 3

In Formula 3, as defined in the Formula 2, M² is titanium (Ti), zirconium (Zr) or hafnium (Hf), and preferably, is equal to the M² of Fomula 2. X is a halogen atom, for example, fluorine, chlorine, bromine, iodine and so on.

Non-limiting examples of the organometallic compound represented by Formula 1 include cyclopentadienyl lithium, methylcyclopentadienyl lithium, 1,2,3,4-tetramethylcyclopentadienyl lithium, ethylcyclopentadienyl lithium, propylcyclopentadienyl lithium, butylcyclopentadienyl lithium, isobutylcyclopentadienyl lithium, octadecylcyclopentadienyl lithium, cyclopentylcyclopentadienyl lithium, cyclohexylcyclopentadienyl lithium, 1,3-butylmethyl cyclopentadienyl lithium, indenyl lithium, 1-methylindenyl lithium, 2-methylindenyl lithium, 1-ethylindenyl lithium, 2-ethylindenyl lithium, 1-propylindenyl lithium, 2-propylindenyl lithium, 2-phenylindenyl lithium, 3-phenylindenyl lithium, fluorenyl lithium, cyclopentadienyl sodium, methylcyclopentadienyl sodium, 1,2,3,4-tetramethylcyclopentadienyl sodium, ethylcyclopentadienyl sodium, propylcyclopentadienyl sodium, butylcyclopentadienyl sodium, isobutylcyclopentadienyl sodium, octadecylcyclopentadienyl sodium, cyclopentylcyclopentadienyl sodium, cyclohexylcyclopentadienyl sodium, 1,3-butylmethyl cyclopentadienyl sodium, indenyl sodium, 1-methylindenyl sodium, 2-methylindenyl sodium, 1-ethylindenyl sodium, 2-ethylindenyl sodium, 1-propylindenyl sodium, 2-propylindenyl sodium, 2-phenylindenyl sodium, 3-phenylindenyl sodium, fluorenyl sodium, cyclopentadienyl magnesium methyl, cyclopentadienyl magnesium ethyl, cyclopentadienyl magnesium isobutyl, cyclopentadienyl magnesium propyl, cyclopentadienyl magnesium heptyl, cyclopentadienyl magnesium octyl, methylcyclopentadienyl magnesium methyl, methylcyclopentadienyl magnesium ethyl, methylcyclopentadienyl magnesium isobutyl, methylcyclopentadienyl magnesium propyl, methylcyclopentadienyl magnesium heptyl, methylcyclopentadienyl magnesium octyl, 1,2,3,4-tetramethylcyclopentadienyl magnesium methyl, 1,2,3,4-tetramethylcyclopentadienyl magnesium ethyl, 1,2,3,4-tetramethylcyclopentadienyl magnesium isobutyl, 1,2,3,4-tetramethylcyclopentadienyl magnesium propyl, 1,2,3,4-tetramethylcyclopentadienyl magnesium heptyl, 1,2,3,4-tetramethylcyclopentadienyl magnesium octyl, ethylcyclopentadienyl magnesium methyl, ethylcyclopentadienyl magnesium ethyl, ethylcyclopentadienyl magnesium isobutyl, ethylcyclopentadienyl magnesium propyl, ethylcyclopentadienyl magnesium heptyl, ethylcyclopentadienyl magnesium octyl, propylcyclopentadienyl magnesium methyl, propylcyclopentadienyl magnesium ethyl, propylcyclopentadienyl magnesium isobutyl, propylcyclopentadienyl magnesium propyl, propylcyclopentadienyl magnesium heptyl, propylcyclopentadienyl magnesium octyl, butylcyclopentadienyl magnesium methyl, butylcyclopentadienyl magnesium ethyl, butylcyclopentadienyl magnesium isobutyl, butylcyclopentadienyl magnesium propyl, butylcyclopentadienyl magnesium heptyl, butylcyclopentadienyl magnesium octyl, isobutylcyclopentadienyl magnesium methyl, isobutylcyclopentadienyl magnesium ethyl, isobutylcyclopentadienyl magnesium isobutyl, isobutylcyclopentadienyl magnesium propyl, isobutylcyclopentadienyl magnesium heptyl, isobutylcyclopentadienyl magnesium octyl, octadecylcyclopentadienyl magnesium methyl, octadecylcyclopentadienyl magnesium ethyl, octadecylcyclopentadienyl magnesium isobutyl, octadecylcyclopentadienyl magnesium propyl, octadecylcyclopentadienyl magnesium heptyl, octadecylcyclopentadienyl magnesium octyl, cyclopentylcyclopentadienyl magnesium methyl, cyclopentylcyclopentadienyl magnesium ethyl, cyclopentylcyclopentadienyl magnesium isobutyl, cyclopentylcyclopentadienyl magnesium propyl, cyclopentylcyclopentadienyl magnesium heptyl, cyclopentylcyclopentadienyl magnesium octyl, cyclohexylcyclopentadienyl magnesium methyl, cyclohexylcyclopentadienyl magnesium ethyl, cyclohexylcyclopentadienyl magnesium isobutyl, cyclohexylcyclopentadienyl magnesium propyl, cyclohexylcyclopentadienyl magnesium heptyl, cyclohexylcyclopentadienyl magnesium octyl, 1,3-butylmethyl cyclopentadienyl magnesium methyl, 1,3-butylmethyl cyclopentadienyl magnesium ethyl, 1,3-butylmethyl cyclopentadienyl magnesium isobutyl, 1,3-butylmethyl cyclopentadienyl magnesium propyl, 1,3-butylmethyl cyclopentadienyl magnesium heptyl, 1,3-butylmethyl cyclopentadienyl magnesium octyl, bis(cyclopentadienyl)magnesium, bis(alkyl-cyclopentadienyl)magnesium, bis(indenyl)magnesium, bis(alkylindenyl)magnesium, indenyl magnesium methyl, indenyl magnesium ethyl, indenyl magnesium isobutyl, indenyl magnesium propyl, indenyl magnesium heptyl, indenyl magnesium octyl, 2-methylindenyl magnesium methyl, 2-methylindenyl magnesium ethyl, 2-methylindenyl magnesium isobutyl, 2-methylindenyl magnesium propyl, 2-methylindenyl magnesium heptyl, 2-methylindenyl magnesium octyl, 3-methylindenyl magnesium methyl, 3-methylindenyl magnesium ethyl, 3-methylindenyl magnesium isobutyl, 3-methylindenyl magnesium propyl, 3-methylindenyl magnesium heptyl, 3-methylindenyl magnesium octyl, 2-phenylindenyl magnesium methyl, 2-phenylindenyl magnesium ethyl, 2-phenylindenyl magnesium isobutyl, 2-phenylindenyl magnesium propyl, 2-phenylindenyl magnesium heptyl, 2-phenylindenyl magnesium octyl, 3-phenylindenyl magnesium methyl, 3-phenylindenyl magnesium ethyl, 3-phenylindenyl magnesium isobutyl, 3-phenylindenyl magnesium propyl, 3-phenylindenyl magnesium heptyl, 3-phenylindenyl magnesium octyl, fluorenyl magnesium methyl, fluorenyl magnesium ethyl, fluorenyl magnesium isobutyl, fluorenyl magnesium propyl, fluorenyl magnesium heptyl, fluorenyl magnesium octyl, cyclopentadienyl aluminium dimethyl, cyclopentadienyl aluminium diethyl, cyclopentadienyl aluminium diisobutyl, cyclopentadienyl aluminium dipropyl, cyclopentadienyl aluminium diheptyl, cyclopentadienyl aluminium dioctyl, methylcyclopentadienyl aluminium dimethyl, methylcyclopentadienyl aluminium diethyl, methylcyclopentadienyl aluminium diisobutyl, methylcyclopentadienyl aluminium dipropyl, methylcyclopentadienyl aluminium diheptyl, methylcyclopentadienyl aluminium dioctyl, 1,2,3,4-tetramethylcyclopentadienyl aluminium dimethyl, 1,2,3,4-tetramethylcyclopentadienyl aluminium diethyl, 1,2,3,4-tetramethylcyclopentadienyl aluminium diisobutyl, 1,2,3,4-tetramethylcyclopentadienyl aluminium dipropyl, 1,2,3,4-tetramethylcyclopentadienyl aluminium diheptyl, 1,2,3,4-tetramethylcyclopentadienyl aluminium dioctyl, ethylcyclopentadienyl aluminium dimethyl, ethylcyclopentadienyl aluminium diethyl, ethylcyclopentadienyl aluminium diisobutyl, ethylcyclopentadienyl aluminium dipropyl, ethylcyclopentadienyl aluminium diheptyl, ethylcyclopentadienyl aluminium dioctyl, propylcyclopentadienyl aluminium dimethyl, propylcyclopentadienyl aluminium diethyl, propylcyclopentadienyl aluminium diisobutyl, propylcyclopentadienyl aluminium dipropyl, propylcyclopentadienyl aluminium diheptyl, propylcyclopentadienyl aluminium dioctyl, butylcyclopentadienyl aluminium dimethyl, butylcyclopentadienyl aluminium diethyl, butylcyclopentadienyl aluminium diisobutyl, butylcyclopentadienyl aluminium dipropyl, butylcyclopentadienyl aluminium diheptyl, butylcyclopentadienyl aluminium dioctyl, isobutylcyclopentadienyl aluminium dimethyl, isobutylcyclopentadienyl aluminium diethyl, isobutylcyclopentadienyl aluminium diisobutyl, isobutylcyclopentadienyl aluminium dipropyl, isobutylcyclopentadienyl aluminium diheptyl, isobutylcyclopentadienyl aluminium dioctyl, octadecylcyclopentadienyl aluminium dimethyl, octadecylcyclopentadienyl aluminium diethyl, octadecylcyclopentadienyl aluminium diisobutyl, octadecylcyclopentadienyl aluminium dipropyl, octadecylcyclopentadienyl aluminium diheptyl, octadecylcyclopentadienyl aluminium dioctyl, cyclopentylcyclopentadienyl aluminium dimethyl, cyclopentylcyclopentadienyl aluminium diethyl, cyclopentylcyclopentadienyl aluminium diisobutyl, cyclopentylcyclopentadienyl aluminium dipropyl, cyclopentylcyclopentadienyl aluminium diheptyl, cyclopentylcyclopentadienyl aluminium dioctyl, cyclohexylcyclopentadienyl aluminium dimethyl, cyclohexylcyclopentadienyl aluminium diethyl, cyclohexylcyclopentadienyl aluminium diisobutyl, cyclohexylcyclopentadienyl aluminium dipropyl, cyclohexylcyclopentadienyl aluminium diheptyl, cyclohexylcyclopentadienyl aluminium dioctyl, 1,3-butylmethyl cyclopentadienyl aluminium dimethyl, 1,3-butylmethyl cyclopentadienyl aluminium diethyl, 1,3-butylmethyl cyclopentadienyl aluminium diisobutyl, 1,3-butylmethyl cyclopentadienyl aluminium dipropyl, 1,3-butylmethyl cyclopentadienyl aluminium diheptyl, 1,3-butylmethyl cyclopentadienyl aluminium dioctyl, indenyl aluminium dimethyl, indenyl aluminium diethyl, indenyl aluminium diisobutyl, indenyl aluminium dipropyl, indenyl aluminium diheptyl, indenyl aluminium dioctyl, 2-methylindenyl aluminium dimethyl, 2-methylindenyl aluminium diethyl, 2-methylindenyl aluminium diisobutyl, 2-methylindenyl aluminium dipropyl, 2-methylindenyl aluminium diheptyl, 2-methylindenyl aluminium dioctyl, 3-methylindenyl aluminium dimethyl, 3-methylindenyl aluminium diethyl, 3-methylindenyl aluminium diisobutyl, 3-methylindenyl aluminium dipropyl, 3-methylindenyl aluminium diheptyl, 3-methylindenyl aluminium dioctyl, 2-phenylindenyl aluminium dimethyl, 2-phenylindenyl aluminium diethyl, 2-phenylindenyl aluminium diisobutyl, 2-phenylindenyl aluminium dipropyl, 2-phenylindenyl aluminium diheptyl, 2-phenylindenyl aluminium dioctyl, 3-phenylindenyl aluminium dimethyl, 3-phenylindenyl aluminium diethyl, 3-phenylindenyl aluminium diisobutyl, 3-phenylindenyl aluminium dipropyl, 3-phenylindenyl aluminium diheptyl, 3-phenylindenyl aluminium dioctyl, fluorenyl aluminium dimethyl, fluorenyl aluminium diethyl, fluorenyl aluminium diisobutyl, fluorenyl aluminium dipropyl, fluorenyl aluminium diheptyl, fluorenyl aluminium dioctyl, bis(cyclopentadienyl)aluminium ethyl, bis(cyclopentadienyl)aluminium methyl, bis(methyl-cyclopentadienyl)aluminium ethyl, tris(cyclopentadienyl)aluminium, tris(methyl-cyclopentadienyl) aluminium, bis(indenyl)aluminium ethyl, bis(methyl-indenyl)aluminium ethyl, tris(indenyl)aluminium, tris(methyl-indenyl)aluminium, and so on, which can be used alone or as mixtures of two or more thereof.

Non-limiting examples of the organic transition metal compound represented by Formula 2 include bis(tetrahydroindenyl)zirconium difluoride, bis(1-methyltetrahydroindenyl)zirconium difluoride, bis(1-n-propyltetrahydroindenyl)zirconium difluoride, bis(1-isopropyltetrahydroindenyl)zirconium difluoride, bis(1-n-butyltetrahydroindenyl)zirconium difluoride, bis(1-cyclopentyltetrahydroindenyl)zirconium difluoride, bis(1-cyclohexyltetrahydroindenyl)zirconium difluoride, bis(1,2-dimethyltetrahydroindenyl)zirconium difluoride, bis(1-isobutyltetrahydroindenyl)zirconium difluoride, bis(4-methyltetrahydroindenyl)zirconium difluoride, bis(5-methyltetrahydroindenyl)zirconium difluoride, bis(4,5-dimethyltetrahydroindenyl)zirconium difluoride, bis(5,7-dimethyltetrahydroindenyl)zirconium difluoride, bis(4,5,6,7-tetramethyltetrahydroindenyl)zirconium difluoride, bis(2-methyltetrahydroindenyl)zirconium difluoride, bis(2-n-propyltetrahydroindenyl)zirconium difluoride, bis(2-isopropyltetrahydroindenyl)zirconium difluoride, bis(2-n-butyltetrahydroindenyl)zirconium difluoride, bis(2-cyclopentyltetrahydroindenyl)zirconium difluoride, bis(2-cyclohexyltetrahydroindenyl)zirconium difluoride, bis(1,2-dimethyltetrahydroindenyl)zirconium difluoride, bis(2-isobutyltetrahydroindenyl)zirconium difluoride, bis(tetrahydroindenyl)zirconium dichloride, bis(1-methyltetrahydroindenyl)zirconium dichloride, bis(1-n-propyltetrahydroindenyl)zirconium dichloride, bis(1-isopropyltetrahydroindenyl)zirconium dichloride, bis(1-n-butyltetrahydroindenyl)zirconium dichloride, bis(1-cyclopentyltetrahydroindenyl)zirconium dichloride, bis(1-cyclohexyltetrahydroindenyl)zirconium dichloride, bis(1,2-dimethyltetrahydroindenyl)zirconium dichloride, bis(1-isobutyltetrahydroindenyl)zirconium dichloride, bis(4-methyltetrahydroindenyl)zirconium dichloride, bis(5-methyltetrahydroindenyl)zirconium dichloride, bis(4,5-dimethyltetrahydroindenyl)zirconium dichloride, bis(5,7-dimethyltetrahydroindenyl)zirconium dichloride, bis(4,5,6,7-tetramethyltetrahydroindenyl)zirconium dichloride, bis(2-methyltetrahydroindenyl)zirconium dichloride, bis(2-n-propyltetrahydroindenyl)zirconium dichloride, bis(2-isopropyltetrahydroindenyl)zirconium dichloride, bis(2-n-butyltetrahydroindenyl)zirconium dichloride, bis(2-cyclopentyltetrahydroindenyl)zirconium dichloride, bis(2-cyclohexyltetrahydroindenyl)zirconium dichloride, bis(1,2-dimethyltetrahydroindenyl)zirconium dichloride, bis(2-isobutyltetrahydroindenyl)zirconium dichloride, bis(tetrahydroindenyl)zirconium dibromide, bis(1-methyltetrahydroindenyl)zirconium dibromide, bis(1-n-propyltetrahydroindenyl)zirconium dibromide, bis(1-isopropyltetrahydroindenyl)zirconium dibromide, bis(1-n-butyltetrahydroindenyl)zirconium dibromide, bis(1-cyclopentyltetrahydroindenyl)zirconium dibromide, bis(1-cyclohexyltetrahydroindenyl)zirconium dibromide, bis(1,2-dimethyltetrahydroindenyl)zirconium dibromide, bis(1-isobutyltetrahydroindenyl)zirconium dibromide, bis(4-methyltetrahydroindenyl)zirconium dibromide, bis(5-methyltetrahydroindenyl)zirconium dibromide, bis(4,5-dimethyltetrahydroindenyl)zirconium dibromide, bis(5,7-dimethyltetrahydroindenyl)zirconium dibromide, bis(4,5,6,7-tetramethyltetrahydroindenyl)zirconium dibromide, bis(2-methyltetrahydroindenyl)zirconium dibromide, bis(2-n-propyltetrahydroindenyl)zirconium dibromide, bis(2-isopropyltetrahydroindenyl)zirconium dibromide, bis(2-n-butyltetrahydroindenyl)zirconium dibromide, bis(2-cyclopentyltetrahydroindenyl)zirconium dibromide, bis(2-cyclohexyltetrahydroindenyl)zirconium dibromide, bis(1,2-dimethyltetrahydroindenyl)zirconium dibromide, bis(2-isobutyltetrahydroindenyl)zirconium dibromide, bis(tetrahydroindenyl)zirconium diiodide, bis(1-methyltetrahydroindenyl)zirconium diiodide, bis(1-n-propyltetrahydroindenyl)zirconium diiodide, bis(1-isopropyltetrahydroindenyl)zirconium diiodide, bis(1-n-butyltetrahydroindenyl)zirconium diiodide, bis(1-cyclopentyltetrahydroindenyl)zirconium diiodide, bis(1-cyclohexyltetrahydroindenyl)zirconium diiodide, bis(1,2-dimethyltetrahydroindenyl)zirconium diiodide, bis(1-isobutyltetrahydroindenyl)zirconium diiodide, bis(4-methyltetrahydroindenyl)zirconium diiodide, bis(5-methyltetrahydroindenyl)zirconium diiodide, bis(4,5-dimethyltetrahydroindenyl)zirconium diiodide, bis(5,7-dimethyltetrahydroindenyl)zirconium diiodide, bis(4,5,6,7-tetramethyltetrahydroindenyl)zirconium diiodide, bis(2-methyltetrahydroindenyl)zirconium diiodide, bis(2-n-propyltetrahydroindenyl)zirconium diiodide, bis(2-isopropyltetrahydroindenyl)zirconium diiodide, bis(2-n-butyltetrahydroindenyl)zirconium diiodide, bis(2-cyclopentyltetrahydroindenyl)zirconium diiodide, bis(2-cyclohexyltetrahydroindenyl)zirconium diiodide, bis(1,2-dimethyltetrahydroindenyl)zirconium diiodide, bis(2-isobutyltetrahydroindenyl)zirconium diiodide, and so on, which can be used alone or as mixtures of two or more thereof. And, the organic transition metal compound represented by Formula 2 is not limited by the above stated examples, and includes an organic transition metal compound consisting of ligands having other substituted or unsubstituted tetrahydroindenyl(4HInd) nucleus.

Non-limiting examples of the organic transition metal compound represented by Formula 3 include titanium fluoride, titanium chloride, titanium bromide, titanium iodide, zirconium fluoride, zirconium chloride, zirconium bromide, zirconium iodide, hafnium fluoride, hafnium chloride, hafnium bromide, hafnium iodide, and so on. The compounds represented by Formulas 1 to 3 can be prepared by a conventional method for preparing metallocene compounds, or can be commercially available easily.

The aluminoxane comprised in the olefin polymerization catalyst composition according to the present invention, is for activating catalyst component and scavenging impurities, and may have a linear, cyclic or network structure. As the aluminoxane, a compound represented by the following Formula 4 can be used, and, for example, a linear aluminoxane represented by the following Formula 5, a cyclic aluminoxane represented by the following Formula 6, and so on, can be used.

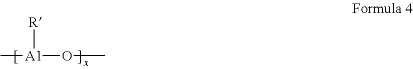

In Formula 4, R′ is a hydrocarbyl radical of 1 to 10 carbon atoms, and x is an integer of 1 to 70.

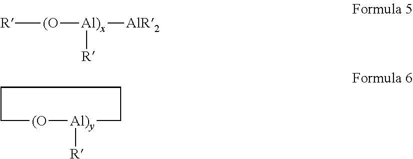

In Formulas 5 and 6, R′ is independently a hydrocarbyl radical, preferably a linear or a branched alkyl radical of 1 to 10 carbon atoms. More preferably, most of R′ is methyl groups. x is an integer of 1 to 50, preferably 10 to 40. y is an integer of 3 to 50, preferably 10 to 40.

In the present invention, as the aluminoxane, an alkyl aluminoxane which is commercially available can be used. The non-limiting examples of the alkyl aluminoxane include methylaluminoxane, ethylaluminoxane, butylaluminoxane, isobutylaluminoxane, hexylaluminoxane, octylaluminoxane, decylaluminoxane, and so on. The aluminoxane is commercially available in various forms of hydrocarbon solutions. Preferable aluminoxane is an aromatic hydrocarbon solution of aluminoxane, and more preferable aluminoxane is an aluminoxane dissolved in toluene. In the present invention, a single aluminoxane or mixtures of more than one aluminoxanes can be used. The alkyl aluminoxane can be prepared by various conventional methods such as adding proper amount of water to trialkylaluminum, or reacting a hydrocarbyl compound having water or an inorganic hydrated salt with trialkylaluminum. Conventionally, a mixture of linear aluminoxane and cyclic aluminoxane is obtained.

In the olefin polymerization catalyst composition according to the present invention, with respect to 1 mole of the total organic transition metal compounds of Formulas 2 and 3, the amount of the organometallic compound represented by Formula 1 is 0.2 to 20 mole, preferably 0.5 to 10 mole, and the amount of aluminium of the aluminoxane is 1 to 100,000 mole, preferably, 5 to 2,500 mole, more preferably 5 to 1,000 mole, most preferably 10 to 500. The mole ratio of the organic transition metal compound represented by Formula 2: the organic transition metal compound represented by Formula 3 is 1:0.8 to 1.2, preferably 0.9 to 1.1. Wherein, if the amounts of the organometallic compound represented by Formula 1 and the organic transition metal compounds of Formulas 2 and 3 are out of range, the performance of catalyst may be deteriorated.

In the olefin polymerization catalyst composition according to the present invention, each component can be mixed without specific limitations. For example, the four components (compounds) can be mixed for 5 minutes to 24 hours, preferably 15 minutes to 16 hours simultaneously. Alternatively, the organometallic compound represented by Formula 1 and the aluminoxane are mixed first for 5 minutes to 10 hours, preferably for 15 minutes to 4 hours, and then, a reaction mixture of the organic transition metal compounds represented by Formulas 2 and 3 and the aluminoxane is added thereto and mixed for 5 minutes to 24 hours, preferably for 15 minutes to 16 hours. It is desirable that the compounds should be mixed under an inert atmosphere of nitrogen or argon, without a solvent, or in the presence of an inert hydrocarbon solvent such as heptane, hexane, benzene, toluene, xylene or mixtures thereof. The temperature of the mixing process is 0 to 150° C., preferably 10 to 90° C. The catalyst solution in which the catalyst is uniformly dissolved in the hydrocarbon solvent can be used as it stands, or the catalyst in a solid powder state after the solvent has been removed can be used. The catalyst in a solid powder state can be prepared by carrying out a precipitation reaction of the catalyst solution, and solidifying the precipitate from the reaction.

The olefin polymerization catalyst composition according to the present invention may further comprise an organic or inorganic carrier which supports the organometallic compound represented by Formula 1, the organic transition metal compound represented by Formula 2, the organic transition metal compound represented by Formula 3 and the aluminoxane. Therefore, the catalyst composition of the present invention can exist in a form supported by a carrier or a form of an insoluble particle of the carrier, as well as a form of a homogeneous solution.

The method for contacting the catalyst composition of the present invention with the carrier will be explained, but the present invention is not limited to the following methods. At first, a solution state catalyst is prepared by mixing the organometallic compound represented by Formula 1; the organic transition metal compound represented by Formula 2; the organic transition metal compound represented by Formula 3; and the aluminoxane, and the catalyst is contacted with a porous carrier (for example, a silica carrier having pore sizes of 50 to 500 Å and a pore volume of 0.1 to 5.0 cm³/g) to form a slurry. Next, the catalyst of the slurry state is treated with an acoustic wave or oscillating wave having the frequency of 1 to 10.000 kHz at 0° C. to 120° C. for 1 to 6 hours to uniformly infiltrate the catalyst components into the pores of the carrier. And then, the catalyst slurry is dried under vacuum or nitrogen flow to form a catalyst of a solid powder state. The acoustic wave or oscillating wave is preferably ultrasonic waves, and more preferably a wave of the frequency of 20 to 500 kHz. After applying the acoustic wave or the oscillating wave to the catalyst, the step of supporting the catalyst on a carrier may also include the step of washing the supported catalyst with a hydrocarbon selected from the group consisting of pentane, hexane, heptane, isoparaffin, toluene, xylene and mixtures thereof.

As the carrier, porous inorganic compounds, inorganic salts, and organic compounds with micro pores and a large surface area can be used without restrictions. The shape of the inorganic carrier is not limited if the shape can be maintained during the preparation process of the supported catalysts, and may be in any shape such as powder, particle, flake, foil, fiber, and so on. Regardless of the shape of the inorganic carrier, the maximum length of the inorganic carrier is generally from 5 to 200 μm, preferably from 10 to 100 μm, the preferable surface area of the inorganic carrier is 50 to 1,000 m²/g and the preferable pore volume is 0.05 to 5 cm³/g. Generally, the inorganic carrier should be treated to remove water or hydroxyl group thereform before the use. The treatment can be carried out by calcining the carrier at 200° C. to 900° C. under an inert atmosphere such as air, nitrogen, argon, or so on. Non-limiting examples of the inorganic salt carrier or the inorganic carrier include silica, alumina, bauxite, zeolite, magnesium chloride (MgCl₂), calcium chloride (CaCl₂), magnesium oxide (MgO), zirconium dioxide (ZrO₂), titanium dioxide (TiO₂), boron trioxide (B₂O₃), calcium oxide (CaO), zinc oxide (ZnO), barium oxide (BaO), thorium oxide (ThO₂) and mixtures thereof such as silica-magnesium oxide (SiO₂—MgO), silica-alumina (SiO₂—Al₂O₃), silica-titanium dioxide (SiO₂—TiO₂), silica-vanadium pentoxide (SiO₂—V₂O₅), silica-chromium trioxide (SiO₂—CrO₃), silica-titanium dioxide-magnesium oxide (SiO₂—TiO₂—MgO) or so on. Small amount of carbonate, sulfate, or nitrate can be added to these compounds. Non-limiting examples of the organic carrier include starch, cyclodextrin, synthetic polymer or so on. Examples of the solvent, which is used for bringing the catalyst of the present invention into contact with the carrier, include an aliphatic hydrocarbon solvent such as pentane, hexane, heptane, octane, nonane, decane, undecane, dodecane and so on, an aromatic hydrocarbon solvent such as benzene, monochlorobenzene, dichlorobenzene, trichlorobenzene, toluene and so on, a halogenated aliphatic hydrocarbon solvent such as dichloromethane, trichloromethane, dichloroethane, trichloroethane, and so on. The solvent or the mixtures thereof can be used for the supporting process.

The present invention also provides an olefin polymerization process including the step of polymerizing at least one olefin in the presence of the polymerization catalyst composition. The olefin polymerization catalyst composition of the present invention can exist in a form supported by an inorganic carrier (silica, alumina, silica-alumina mixture, and so on) or a form of an insoluble particle of the carrier, as well as a form of a homogeneous solution. Thus, the olefin polymerization catalyst composition can be used for a solution phase, a slurry phase, a bulk phase or a gas phase polymerization reaction. The conditions for the polymerization reactions can be varied according to the state of the catalyst (homogeneous or heterogeneous phase (supported phase)), the polymerization method (solution polymerization, slurry polymerization, gas phase polymerization), target polymer properties or the polymer shape. Such variation can be easily carried out by a skilled person in the art. When the polymerization is carried out in a solution phase or a slurry phase, a solvent or olefin itself may work as a reaction medium. Examples of the solvent include propane, butane, pentane, hexane, octane, decane, dodecane, cyclopentane, methylcyclopentane, cyclohexane, benzene, toluene, xylene, dichloromethane, chloroethane, 1,2-dichloroethane, chlorobenzene, and so on, and, if necessary, mixtures of the solvents can be used.

The olefin polymerization catalyst composition of the present invention can be used for a copolymerization of olefin monomers/comonomers as well as a homopolymerization of olefin monomers. Preferable examples of the olefin for the polymerization or the copolymerization include α-olefins, cyclic olefins, dienes, trienes, styrenes, and so on. The α-olefins include an aliphatic olefin of 2 to 12, preferably 2 to 8 carbon atoms, more specifically includes ethylene, propylene, butene-1, pentene-1,3-methylbutene-1, hexene-1,4-methylpentene-1,3-methylpentene-1, heptene-1, octene-1, decene-1,4,4-dimethyl-1-pentene, 4,4-diethyl-1-hexene, 3,4-dimethyl-1-hexene, or so on. The α-olefins may be polymerized to form a homo-polymer, an alternating copolymer, a random copolymer or a block copolymer. The copolymerization of the α-olefins includes the copolymerization of ethylene and α-olefin of 3 to 12, preferably 3 to 8 carbon atoms (for example, ethylene and propylene, ethylene and butene-1, ethylene and hexene-1, ethylene and 4-methylpentene-1, ethylene and octene-1, and so on) and the copolymerization of propylene and α-olefin of 4 to 12, preferably 4 to 8 carbon atoms (propylene and butene-1, propylene and 4-methylpentene-1, propylene and 4-methylbutene-1, propylene and hexene-1, propylene and octene-1). In the copolymerization of ethylene or propylene and other α-olefin, the amount of the other α-olefin may be 90 mole % or less with respect to the total monomer. In case of a conventional ethylene copolymer, the amount of the other α-olefin may be 40 mole % or less, preferably 30 mole % or less, and more preferably 20 mole % or less with respect to the total monomer. In case of a conventional propylene copolymer, the amount of the other α-olefin may be 1 to 90 mole %, preferably 5 to 90 mole %, and more preferably 10 to 70 mole % with respect to the total monomer.

As the cyclic olefins, cyclic olefins of 3 to 24, preferably 3 to 18 carbon numbers can be used. Examples of the cyclic olefins include cyclopentene, cyclobutene, cyclohexene, 3-methylcyclohexene, cyclooctene, tetracyclodecene, octacyclodecene, dicyclopentadiene, norbonene, 5-methyl-2-norbonene, 5-ethyl-2-norbonene, 5-isobutyl-2-norbonene, 5,6-dimethyl-2-norbonene, 5,5,6-trimethyl-2-norbonene, ethylene norbonene, and so on. The cyclic olefins can be copolymerized with the α-olefins, and the amount of the cyclic olefin is 1 to 50 mole %, preferably 2 to 50 mole % with respect to the copolymer. The preferable dienes and trienes include a polyene of 4 to 26 carbon atoms having two or three double bonds. Specific examples of the dienes and the trienes include 1,3-butadiene, 1,4-pentadiene, 1,4-hexadiene, 1,5-hexadiene, 1,9-decadiene, 2-methyl-1,3-butadiene, and so on. Preferable examples of the styrenes include styrene or substituted styrene substituted with an alkyl group, alkoxy group or halogenated alkyl group of 1 to 10 carbon atoms, a halogen group, an amine group, a silyl group, and so on.

In the polymerization or copolymerization of α-olefin according to the present invention, the amount of the catalyst composition used is not limited especially. However, the concentration of the central metal of the organic transition metal compound of Formulas 2 and 3 is preferably 10⁻⁸ to 10¹ mol/l, and more preferably 10⁻⁷ to 10⁻² mol/l in a polymerization reaction system. In the olefin polymerization or copolymerization of the present invention, the polymerization temperature is not especially limited because it can be varied according to reactants, reaction conditions, and so on. However, the polymerization temperature is generally 0 to 250° C., and more preferably 10 to 200° C. in a solution polymerization, and generally 0 to 120° C., and more preferably 20 to 100° C. in a slurry or a gas phase polymerization. The polymerization pressure is generally atmospheric pressure to 500 kg/cm², and more preferably atmospheric pressure to 50 kg/cm². The polymerization reaction can be carried out in a batch type, a semi-continuous type, or a continuous type reaction. The polymerization can be carried out by two or more steps of different reaction conditions. The molecular weight of the resulting polymer can be controlled by changing the polymerization temperature, or by injecting hydrogen into a reactor.

The olefin polymerization catalyst composition of the present invention can be used not only in a main polymerization of olefin monomers but also in a prepolymerization of olefin monomers. In the prepolymerization process, the olefin polymer or copolymer is produced in the amount of 0.05 to 500 g, preferably 0.1 to 300 g, and more preferably 0.2 to 100 g with respect to 1 g of the catalyst. Examples of the olefin suitable for the prepolymerization, include α-olefin of 2 to 20 carbon atoms, such as ethylene, propylene, 1-butene, 1-pentene, 4-methyl-1-pentene, 1-hexene, 1-octene, 1-decene, 1-dodecene, 1-tetradecene, 3-methyl-1-butene, 3-methyl-1-pentene, and so on. And it is preferable that olefin for the prepolymerization is the same one for the main polymerization.

Hereinafter, the preferable examples are provided for better understanding of the present invention. However, the present invention is not limited to the following examples. In the following examples, the olefin polymerization catalyst was produced with Schlenk method in which air and moisture were completely blocked, and purified and dried nitrogen was used as an inert gas. Solvent was dried with sodium metal under inert nitrogen atmosphere. Melt Index (MI) and HLMI (high load Melt Index) of polymer were measured in accordance with ASTM D1238, and a density of polymer was measured in accordance with ASTM D1505.

### Example 1

### Preparation of Catalyst and Solution Polymerization of Ethylene

In a 500 ml flask of nitrogen atmosphere, indenyl aluminium diethyl(Ind-AlEt₂) 5.1 mg (0.018 mmol), bis(tetrahydroindenyl)zirconium dichloride 2.4 mg (Mw: 401, 0.006 mmol), zirconium chloride (ZrCl₄) 1.4 mg (0.006 mmol) and methyl aluminoxane (MAO, Albemarle company, 10% toluene solution) 10 ml were mixed (Zr=6.0 μmol, Al/Zr mole ratio 2,500), and stirred at 60° C. for 30 minutes to obtain a catalyst solution.

A stainless autoclave reactor of 1 L having a jacket for supplying cooling water for controlling a polymerization temperature was purged with isobutane (one time) and ethylene (five times) at about 85° C. to remove impurities, and then cooled to room temperature. Dried hexane 300 ml and triisobutylaluminum (TIBA) as an impurity remover 1.0 mmol were added into the washed reactor at room temperature, and heated to a polymerization temperature of 70° C. The obtained catalyst solution was directly added into the reactor, and then the reaction pressure was increased to 14 psig with ethylene (pressure 10 psig). The polymerization was carried out for 1 hour, and then reaction gas was discharged, and the reactor was cooled to complete the polymerization reaction. A solution including 300 mL of methanol and 5 weight % of hydrogen chloride (HCl) was added to the reactant and stirred for about 2 hours to neutralize the MAO component and the active catalyst component remained in the reactant. A slurry including the obtained polymer was filtered and washed with water of 2 liters to remove hydrogen chloride component, and the washed polymer was dried at 60° C. to produce 60.5 g of polymer. The catalytic activity of polymerization was 9,967 g polymer/mol Zr·hour, and MI ((Melt Index) of the obtained polymer was 0.18 g/10 min, and the density of the obtained polymer was 0.9467 g/cm³.

### Example 2

### Preparation of Catalyst and Copolymerization of Ethylene/Hexene-1

In a 500 ml flask of nitrogen atmosphere, indenyl aluminium diethyl(Ind-AlEt₂) 318 mg, bis(tetrahydroindenyl)zirconium dichloride 124 mg, zirconium chloride (ZrCl₄) 69 mg and methyl aluminoxane (MAO, Albemarle company, 10% toluene solution) 50 ml were mixed, and stirred at 60° C. for 30 minutes to obtain a catalyst solution. 10 g of silica calcined at 220° C. was added to the produced catalyst solution, and ultrasonic wave was applied for 90 minutes, and the supernatant was discarded. The remaining solid particles were washed with hexane (1 time), and dried in vacuum to obtain a supported catalyst which was free-flowable solid powder.

A stainless autoclave reactor of 1 L having a jacket for supplying cooling water for controlling a polymerization temperature was purged with isobutane (one time) and ethylene (five times) at about 110° C. to remove impurities, and then cooled to 67° C. Isobutane 400 ml and triisobutylaluminum (TIBAL) as an impurity remover 1.0 mmol were added into the washed reactor, and stirred at 75° C. And then, isobutane 100 ml and the obtained supported catalyst 62 mg were added into the reactor. And then, ethylene and 40 ml of 1-hexene were added into the reactor until the partial pressure of ethylene became 130 psig. The polymerization was carried out at 75° C. for 3 hours while maintaining the total pressure of the reactor to 290 psig. During the polymerization, the partial pressure of ethylene was maintained to 130 psig, and 1-hexene was added continuously by 10 weight % to the further added ethylene whose flow was measured by Mass Flowmeter. After completion of the polymerization, unreacted 1-hexene and isobutane were discharged, and the free-flowable polymer 348 g was obtained from the reactor. The polymerization rate during 3 hours of the polymerization reaction was kept steady. The catalytic activity of polymerization was 1,850 g polymer/g·catalyst·hour, and MI ((Melt Index) of the obtained polymer was 1.16 g/10 min, and the density of the obtained polymer was 0.9297 g/cm³.

### Example 3

### Preparation of Catalyst and Copolymerization of Ethylene/Hexene-1

In a 500 ml flask of nitrogen atmosphere, indenyl lithium (Ind-Li) 75 mg, bis(tetrahydroindenyl)zirconium dichloride 124 mg, zirconium chloride (ZrCl₄) 69 mg and methyl aluminoxane (MAO, Albemarle company, 10% toluene solution) 50 ml were mixed, and stirred at 60° C. for 90 minutes to obtain a catalyst solution. 10 g of silica calcined at 220° C. was added to the produced catalyst solution, and ultrasonic wave was applied for 90 minutes, and the supernatant was discarded. The remaining solid particles were washed with hexane (1 time), and dried in vacuum to obtain a supported catalyst of free-flowable solid powder. Except for using the catalyst 61 mg prepared in the above step, the polymerization was carried out for 3 hours in accordance with the polymerization method of Example 2 to obtain the polymer 327 g. The polymerization rate during 3 hours of the polymerization reaction was kept steady. The catalytic activity of polymerization was 1,737 g polymer/g·catalyst·hour, and MI ((Melt Index) of the obtained polymer was 1.14 g/10 min, and the density of the obtained polymer was 0.9308 g/cm³.

### Example 4

### Preparation of Catalyst and Copolymerization of Ethylene/Hexene-1

In a 500 ml flask of nitrogen atmosphere, 2-methylindenyl aluminum diethyl(2-MeInd-AlEt₂) 323 mg, bis(tetrahydroindenyl)zirconium dichloride 124 mg, zirconium chloride (ZrCl₄) 69 mg and methyl aluminoxane (MAO, Albemarle company, 10% toluene solution) 50 ml were mixed, and stirred at 60° C. for 90 minutes to obtain a catalyst solution. 10 g of silica calcined at 220° C. was added to the produced catalyst solution, and ultrasonic wave was applied for 90 minutes, and the supernatant was discarded. The remaining solid particles were washed with hexane (1 time), and dried in vacuum to obtain a supported catalyst which was free-flowable solid powder. Except for using the catalyst 60 mg prepared in the above step, the polymerization was carried out for 3 hours in accordance with the polymerization method of Example 2 to obtain the polymer 274 g. The polymerization rate during 3 hours of the polymerization reaction was kept steady. The catalytic activity of polymerization was 1,522 g polymer/g·catalyst·hour, and MI ((Melt Index) of the obtained polymer was 0.58 g/10 min, and the density of the obtained polymer was 0.9305 g/cm³.

### Example 5

### Preparation of Catalyst and Copolymerization of Ethylene/Hexene-1

In a 500 ml flask of nitrogen atmosphere, 2-methylindenyl lithium (2-MeInd-Li) 85 mg, bis(tetrahydroindenyl)zirconium dichloride 124 mg, zirconium chloride (ZrCl₄) 69 mg and methyl aluminoxane (MAO, Albemarle company, 10% toluene solution) 50 ml were mixed, and stirred at 60° C. for 90 minutes to obtain a catalyst solution. 10 g of silica calcined at 220° C. was added to the produced catalyst solution, and ultrasonic wave was applied for 90 minutes, and the supernatant was discarded. The remaining solid particles were washed with hexane (1 time), and dried in vacuum to obtain a supported catalyst which was free-flowable solid powder. Except for using the catalyst 61 mg prepared in the above step, the polymerization was carried out for 3 hours in accordance with the polymerization method of Example 2 to obtain the polymer 294 g. The polymerization rate during 3 hours of the polymerization reaction was kept steady. The catalytic activity of polymerization was 1,633 g polymer/g·catalyst·hour, and MI ((Melt Index) of the obtained polymer was 0.60 g/10 min, and the density of the obtained polymer was 0.9298 g/cm³.

### Example 6

### Preparation of Catalyst and Copolymerization of Ethylene/Hexene-1

In a 500 ml flask of nitrogen atmosphere, 1-n-butylindenyl lithium (1-n-BuInd-Li) 111 mg, bis(tetrahydroindenyl)zirconium dichloride 124 mg, zirconium chloride (ZrCl₄) 69 mg and methyl aluminoxane (MAO, Albemarle company, 10% toluene solution) 50 ml were mixed, and stirred at 60° C. for 90 minutes to obtain a catalyst solution. 10 g of silica calcined at 220° C. was added to the produced catalyst solution, and ultrasonic wave was applied for 90 minutes, and the supernatant was discarded. The remaining solid particles were washed with hexane (1 time), and dried in vacuum to obtain a supported catalyst which was free-flowable solid powder. Except for using the catalyst 61 mg prepared in the above step, the polymerization was carried out for 3 hours in accordance with the polymerization method of Example 2 to obtain the polymer 205 g. The polymerization rate during 3 hours of the polymerization reaction was kept steady. The catalytic activity of polymerization was 1,120 g polymer/g·catalyst·hour, and MI ((Melt Index) of the obtained polymer was 0.20 g/10 min, and the density of the obtained polymer was 0.9304 g/cm³.

### Example 7

### Preparation of Catalyst and Copolymerization of Ethylene/Hexene-1

In a 500 ml flask of nitrogen atmosphere, 1-ethylindenyl lithium (1-EtInd-Li) 94 mg, bis(tetrahydroindenyl)zirconium dichloride 124 mg, zirconium chloride (ZrCl₄) 69 mg and methyl aluminoxane (MAO, Albemarle company, 10% toluene solution) 50 ml were mixed, and stirred at 60° C. for 90 minutes to obtain a catalyst solution. 10 g of silica calcined at 220° C. was added to the produced catalyst solution, and ultrasonic wave was applied for 90 minutes, and the supernatant was discarded. The remaining solid particles were washed with hexane (1 time), and dried in vacuum to obtain a supported catalyst which was free-flowable solid powder. Except for using the catalyst 60 mg prepared in the above step, the polymerization was carried out for 3 hours in accordance with the polymerization method of Example 2 to obtain the polymer 155 g. The polymerization rate during 3 hours of the polymerization reaction was kept steady. The catalytic activity of polymerization was 861 g polymer/g·catalyst·hour, and MI ((Melt Index) of the obtained polymer was 0.17 g/10 min, and the density of the obtained polymer was 0.9305 g/cm³.

### Example 8

### Preparation of Catalyst and Copolymerization of Ethylene/Hexene-1

In a 500 ml flask of nitrogen atmosphere, indenyl aluminium diethyl(Ind-AlEt₂) 280 mg, bis(tetrahydroindenyl)zirconium dichloride 124 mg, zirconium chloride (ZrCl₄) 69 mg and methyl aluminoxane (MAO, Albemarle company, 10% toluene solution) 50 ml were mixed, and stirred at 80° C. for 60 minutes to obtain a catalyst solution. 10 g of silica calcined at 220° C. was added to the produced catalyst solution, and ultrasonic wave was applied for 90 minutes, and the supernatant was discarded. The remaining solid particles were washed with hexane (1 time), and dried in vacuum to obtain a supported catalyst which was free-flowable solid powder. Except for using the catalyst 60 mg prepared in the above step, the polymerization was carried out for 3 hours in accordance with the polymerization method of Example 2 to obtain the polymer 335 g. The polymerization rate during 3 hours of the polymerization reaction was kept steady. The catalytic activity of polymerization was 1,861 g polymer/g·catalyst·hour, and MI ((Melt Index) of the obtained polymer was 0.98 g/10 min, and the density of the obtained polymer was 0.9296 g/cm³.

### Example 9

### Preparation of Catalyst and Copolymerization of Ethylene/Hexene-1

In a 500 ml flask of nitrogen atmosphere, tetramethyl cyclopentadienyl lithium (Me₄CpLi) 151 mg, bis(tetrahydroindenyl)zirconium dichloride[(4HInd)₂ZrCl₂] 124 mg, zirconium chloride (ZrCl₄) 69 mg and methyl aluminoxane (MAO, Albemarle company, 10% toluene solution) 50 ml were mixed, and stirred at 90° C. for 60 minutes to obtain a catalyst solution. 10 g of silica calcined at 220° C. was added to the produced catalyst solution, and ultrasonic wave was applied for 1 hour, and the supernatant was discarded. The remaining solid particles were washed with hexane (1 time), and dried in vacuum to obtain a supported catalyst which was free-flowable solid powder. Except for using the catalyst 60 mg prepared in the above step, the polymerization was carried out for 3 hours in accordance with the polymerization method of Example 2 to obtain the polymer 210 g. The polymerization rate during 3 hours of the polymerization reaction was kept steady. The catalytic activity of polymerization was 1,167 g polymer/g·catalyst·hour, and MI ((Melt Index) of the obtained polymer was 0.19 g/10 min, and the density of the obtained polymer was 0.9271 g/cm³.

### Comparative Example 1

### Preparation of Catalyst and Copolymerization of Ethylene/Hexene-1

In a 500 ml flask of nitrogen atmosphere, methyl aluminoxane (MAO, Albemarle company, 10% toluene solution) 10 ml and bis(cyclopentadienyl)zirconium dichloride (Cp₂ZrCl₂) 61 mg (0.21 mmol) were mixed, and stirred at room temperature for 30 minutes to obtain a catalyst solution. 2 g of silica calcined at 220° C. was added to the produced catalyst solution, and ultrasonic wave was applied for 1 hour, and the supernatant was discarded. The remaining solid particles were washed with hexane (1 time), and dried in vacuum to obtain a supported catalyst which was free-flowable solid powder. Except for using the catalyst 60 mg prepared in the above step, the polymerization was carried out for 60 minutes in accordance with the polymerization method of Example 2 to obtain the polymer 19 g. The catalytic activity of polymerization was very low as 306 g polymer/g·catalyst·hour.

### Comparative Example 2

### Preparation of Catalyst and Copolymerization of Ethylene/Hexene-1

In a 500 ml flask of nitrogen atmosphere, methyl aluminoxane (MAO, Albemarle company, 10% toluene solution) 11 ml and zirconium chloride (ZrCl₄) 49 mg (0.21 mmol) were mixed, and stirred at room temperature for 3 hours to obtain a catalyst solution. 2 g of silica calcined at 220° C. was added to the produced catalyst solution, and ultrasonic wave was applied for 1 hour, and the supernatant was discarded. The remaining solid particles were washed with hexane (1 time), and dried in vacuum to obtain a supported catalyst which was free-flowable solid powder. Except for using the catalyst 100 mg prepared in the above step, the polymerization was carried out for 30 minutes in accordance with the polymerization method of Example 2 to obtain the polymer 8.6 g. The catalytic activity of polymerization was very low as 86 g polymer/g·catalyst·hour.

As shown in the Examples and Comparative Examples, the catalyst composition according to the present invention has a superior polymerization activity, and especially, can be used to produce a polymer having various melt index (molecular weight) by changing combinations of compounds represented by Formula 1, Formula 2 and Formula 3, preparation conditions (reaction time of the compound and aluminoxane, and so on) for catalyst, polymerization conditions (temperature and so on) and so on. Therefore, the catalyst composition according to the present invention has a superior polymerization activity, though it is produced by a very simple process, and can be used to produce olefin polymers having various molecular weight and melt index (MI) by changing components and mixing ratio of the compound.

What is claimed is:

1. An olefin polymerization catalyst composition comprising:
an organometallic compound represented by Formula 1,
(Cp′)ₗM¹R¹ₘR²ₙ Formula 1
in Formula 1, M¹ is an element selected from the group consisting of elements of Group 1, 2, 12, 13 and 14 of the Periodic Table, (Cp′) is a cyclic hydrocarbyl group of 5 to 30 carbon atoms having at least 2 conjugated double bonds, R¹ and R² are independently a hydrocarbyl group of 1 to 24 carbon atoms, l is an integer of 1 to the valence of M¹, m and n are independently an integer of 0 to 2, and l+m+n is equal to the valence of M¹;
an organic transition metal compound represented by Formula 2,
(4HInd)₂M²X₂ Formula 2
in Formula 2, (4HInd) is a group having tetrahydroindenyl nucleus, M² is titanium (Ti), zirconium (Zr) or hafnium (Hf), and X is a halogen atom;
an organic transition metal compound represented by Formula 3,
M²X₄ Formula 3
in Formula 3, M² is titanium (Ti), zirconium (Zr) or hafnium (Hf), and X is a halogen atom; and
an aluminoxane.

2. The olefin polymerization catalyst composition according to claim 1, wherein M¹ is selected from the group consisting of Lithium (Li), Sodium (Na), Potassium (K), Magnesium (Mg), Zinc (Zn), Boron (B), Aluminum (Al), Gallium (Ga), Indium (In) and Thallium (Tl), and (Cp′) is selected from the group consisting of a substituted or non-substituted cyclopentadienyl group, indenyl group, azulenyl group, and fluorenyl group.

3. The olefin polymerization catalyst composition according to claim 1, wherein (Cp′) and (4HInd) are substituted by a radical selected from the group consisting of an alkyl, alkoxy, alkylsilyl, alkylsiloxy, alkylamino or haloalkyl group of 1 to 20 carbon atoms, an alkenyl or cycloalkyl group of 3 to 20 carbon atoms, an aryl, arylsilyl or aryloxy group of 6 to 20 carbon atoms, an arylalkyl or alkylaryl group of 7 to 20 carbon atoms, a halogen atom, and an amino group.

4. The olefin polymerization catalyst composition according to claim 1, wherein, with respect to 1 mole of the total organic transition metal compounds of Formulas 2 and 3, the amount of the organometallic compound represented by Formula 1 is 0.2 to 20 mole and the amount of aluminium of the aluminoxane is 1 to 100,000 mole, and the mole ratio of the organic transition metal compound represented by Formula 2: the organic transition metal compound represented by Formula 3 is 1:0.8 to 1.2.

5. The olefin polymerization catalyst composition according to claim 1, wherein the olefin polymerization catalyst composition further comprise an organic or inorganic carrier which supports the organometallic compound represented by Formula 1, the organic transition metal compound represented by Formula 2, the organic transition metal compound represented by Formula 3 and the aluminoxane.

6. An olefin polymerization method including a step of polymerizing at least one olefin in the presence of an olefin polymerization catalyst composition which comprises an organometallic compound represented by Formula 1,
(Cp′)ₗM¹R¹ₘR²ₙ Formula 1
in Formula 1, M¹ is an element selected from the group consisting of elements of Group 1, 2, 12, 13 and 14 of the Periodic Table, (Cp′) is a cyclic hydrocarbyl group of 5 to 30 carbon atoms having at least 2 conjugated double bonds, R¹ and R² are independently a hydrocarbyl group of 1 to 24 carbon atoms, l is an integer of 1 to the valence of M¹, m and n are independently an integer of 0 to 2, and l+m+n is equal to the valence of M¹;
an organic transition metal compound represented by Formula 2,
(4HInd)₂M²X₂ Formula 2
in Formula 2, (4HInd) is a group having tetrahydroindenyl nucleus, M² is titanium(Ti), zirconium(Zr) or hafnium(Hf), and X is a halogen atom;
an organic transition metal compound represented by Formula 3,
M²X₄ Formula 3
in Formula 3, M² is titanium(Ti), zirconium(Zr) or hafnium(Hf), and X is a halogen atom; and
an aluminoxane.

7. The olefin polymerization method according to claim 6, wherein the polymerization reaction is a solution phase, a slurry phase, a bulk phase or a gas phase polymerization reaction.
